(19) United States
(12) Patent Application Publication
(10) Pub. No.: US 2017/0086389 A1
(43) Pub. Date: Mar. 30, 2017

(54) Plant Cage Assembly

(71) Applicant: Randy Ash, Sturgeon Bay, WI (US)

(72) Inventor: Randy Ash, Sturgeon Bay, WI (US)

(21) Appl. No.: 14/866,086

(22) Filed: Sep. 25, 2015

(51) Int. Cl. A01G 9/12

(52) U.S. Cl. CPC A01G 9/126; A01G 9/128

(57) ABSTRACT

A plant cage assembly includes a cage has a plurality of members. Each of the members is movably coupled together such that the cage is positionable between a deployed position and a collapsed position. The cage may surround a plant when the cage is positioned in the deployed position thereby facilitating the cage to support the plant. The cage may be stored when the cage is positioned in the collapsed position.

### BACKGROUND OF THE DISCLOSURE

### Field of the Disclosure

The disclosure relates to cage devices and more particularly pertains to a new cage device for providing adjustable support for a plant.

### SUMMARY OF THE DISCLOSURE

An embodiment of the disclosure meets the needs presented above by generally comprising a cage has a plurality of members. Each of the members is movably coupled together such that the cage is positionable between a deployed position and a collapsed position. The cage may surround a plant when the cage is positioned in the deployed position thereby facilitating the cage to support the plant. The cage may be stored when the cage is positioned in the collapsed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a plant cage assembly according to an embodiment of the disclosure in a deployed position.

FIG. 2 is a top view of an embodiment of the disclosure.

FIG. 3 is a cross sectional view taken along line 3-3 of FIG. 2 of an embodiment of the disclosure.

FIG. 4 is a right side view of an embodiment of the disclosure in a collapsed position.

FIG. 5 is a perspective in-use view of an embodiment of the disclosure.

### DESCRIPTION OF THE PREFERRED EMBODIMENT

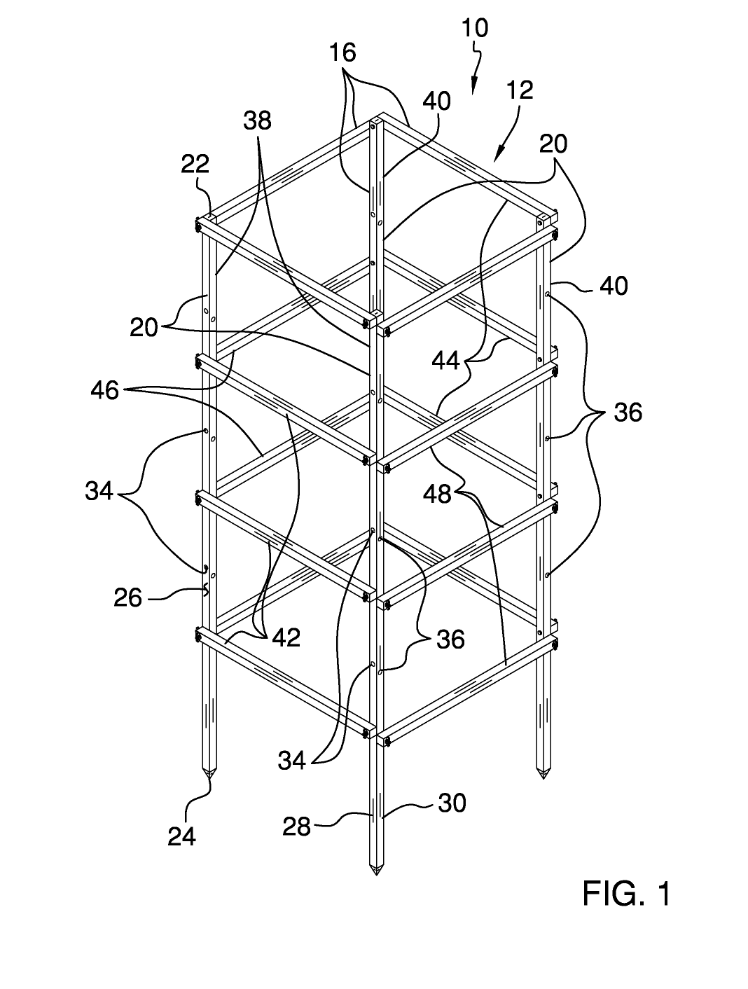

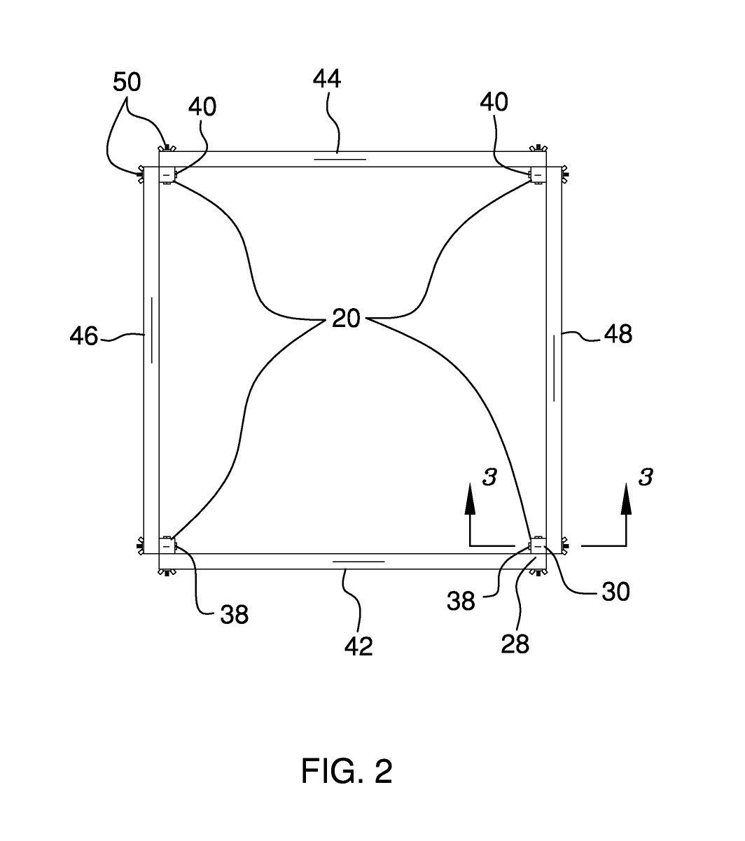

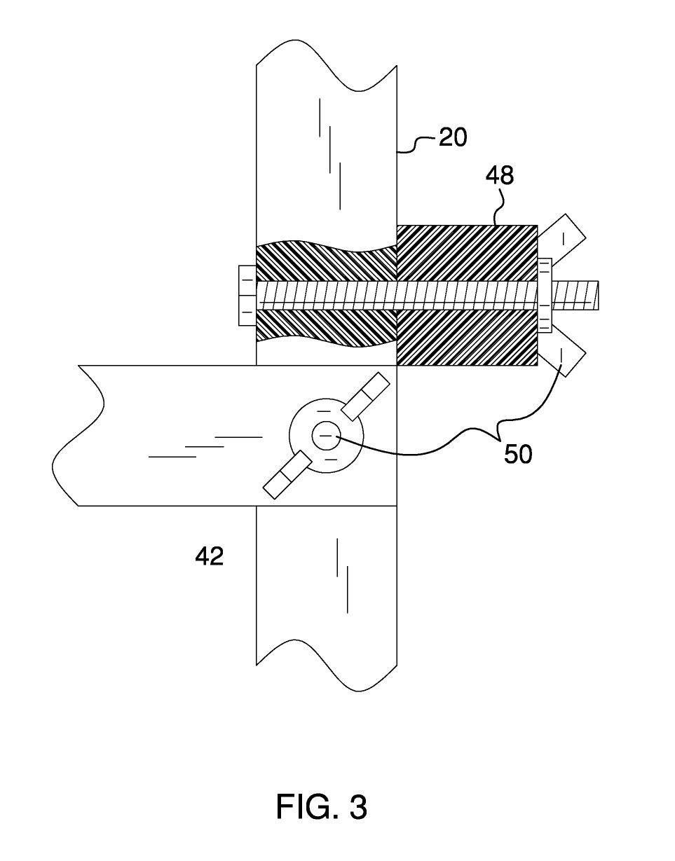

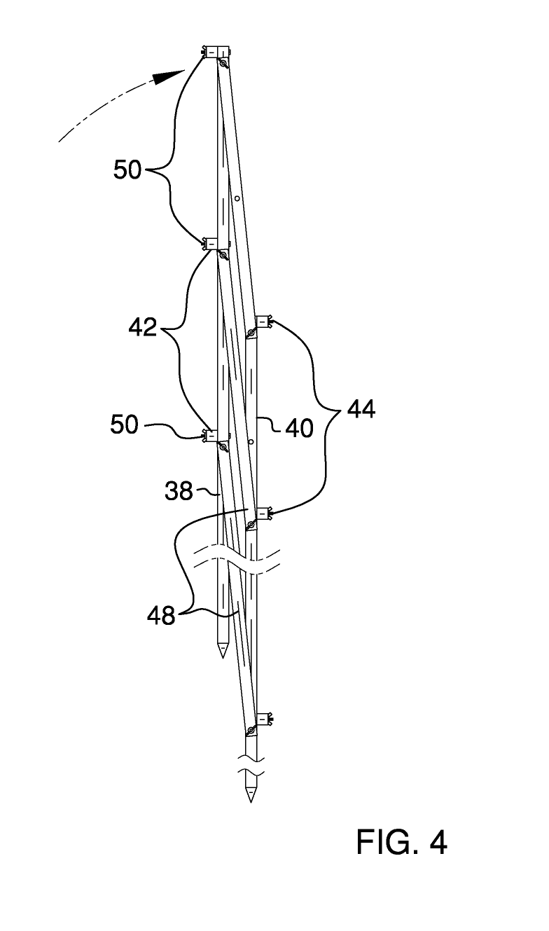

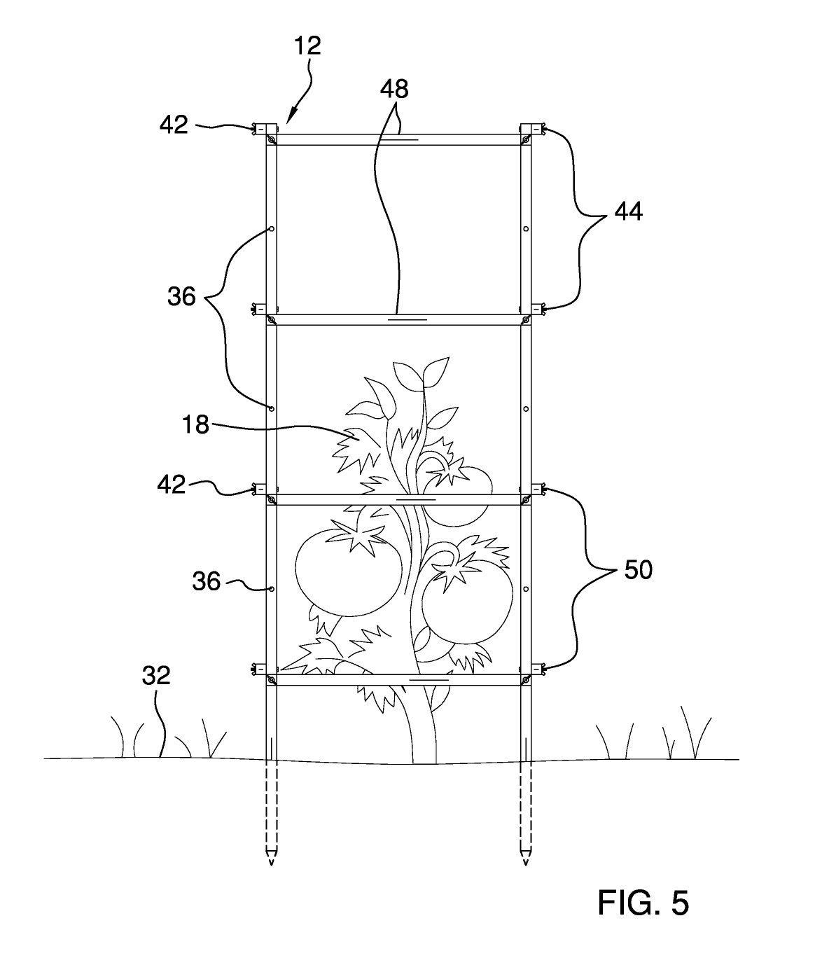

With reference now to the drawings, and in particular to FIGS. 1 through 5 thereof, a new cage device embodying the principles and concepts of an embodiment of the disclosure and generally designated by the reference numeral 10 will be described.

As best illustrated in FIGS. 1 through 5, the plant cage assembly 10 generally comprises a cage 12 that has a plurality of members 16. Each of the members 16 is movably coupled together such that the cage 12 is positionable between a deployed position and a collapsed position. The cage 12 may be positioned to surround a plant 18 when the cage 12 is positioned in the deployed position. Thus, the cage 12 may support the plant 18. The plant 18 may be a tomato plant or the like. The cage 12 may be stored when the cage 12 is positioned in the collapsed position.

The plurality of members 16 comprises a plurality of uprights 20. Each of the uprights 20 has a top end 22, a bottom end 24 and a peripheral surface 26 extending between the top end 22 and the bottom end 24. The peripheral surface 26 has a first side 28 and a second side 30. The first side 28 and the second side 30 form a right angle with each other. Each of the uprights 20 is elongated between the top end 22 and the bottom end 24. The bottom end 24 of each of the uprights 20 is tapered to a point such that the bottom end 24 of each of the uprights 20 may penetrate a support surface 32. The support surface 32 may comprise ground. The plurality of uprights 20 may have a length ranging between approximately one hundred fifty cm and one hundred eighty cm.

Each of the uprights 20 has a plurality of first apertures 34 extending therethrough and each of the first apertures 34 extends through the first side 28. The first apertures 34 on each of the uprights 20 are spaced apart from each other and distributed along each of the uprights 20. The first apertures 34 on each of the uprights may be spaced apart from each other a distance ranging between fifteen cm and twenty cm. Each of the uprights 20 has a plurality of second apertures 36 extending therethrough and each of the second apertures 36 extends through the second side 30. The first apertures 34 are offset with respect to the second apertures 36. The plurality of uprights 20 comprises a pair of first uprights 38 and a pair of second uprights 40.

A first set of supports 42 is provided and each of the first set of supports 42 is movably coupled between the first side 28 corresponding to the pair of first uprights 38. Thus, the pair of first uprights 38 is spaced apart from each other. The first set of supports 42 are spaced apart from each other and distributed along the pair of first uprights 38. Each of the first set of supports 42 may have a length ranging between approximately fifty cm and sixty cm.

A second set of supports 44 is provided and each of the second set of supports 44 is movably coupled between the first side 28 corresponding to the pair of second uprights 40. Thus, the pair of second uprights 40 is spaced apart from each other. The second set of supports 44 is spaced apart from each other and distributed along the second uprights 40. Each of the second set of supports 44 may have a length ranging between approximately fifty cm and sixty cm.

A third set of supports 46 is provided. Each of the third set of supports 46 is movably coupled between the second side 30 corresponding to an associated one of the pair of first uprights 38 and the second side 30 corresponding to an associated one of the second uprights 40. The third set of supports 46 are spaced apart from each other and distributed along the associated first upright 38 and the associated second upright 40. Each of the third set of supports 46 may have a length ranging between approximately fifty cm and sixty cm.

A fourth set of supports 48 is provided. Each of the fourth set of supports 48 is movably coupled between the second side 30 corresponding to an associated one of the pair of first uprights 38 and the second side 30 corresponding to an associated one of the second uprights 40. The fourth set of supports 48 is spaced apart from each other and distributed along the associated first upright 38 and the associated second upright 40. Each of the fourth set of supports 48 may have a length ranging between approximately fifty cm and sixty cm.

A plurality of fasteners 50 is provided. Selected ones of the fasteners 50 extend through an associated one of the first set of supports 42 and the pair of first uprights 38. Selected ones of fasteners 50 extend through the second set of supports 44 and the pair of second uprights 40. Selected ones of the fasteners 50 extend through the third set of supports 46 and the associated first upright 38 and the associated second upright 40. Selected ones of the fasteners 50 extend through the fourth set of supports 48 and the associated first upright 38 and the associated second upright 40.

Each of the fasteners 50 associated with the first set of supports 42 and the second set of supports 44 are extends through a selected one of the first apertures 34. Thus, the first set of supports 42 is positioned a selected distance apart from each other and the second set of supports 44 is spaced a selected distance apart from each other. Each of the fasteners 50 associated with the third set of supports 46 and the fourth set of supports 48 extends through a selected one of the second apertures 36. Thus, the third set of supports 46 is positioned a selected distance apart from each other and the fourth set of supports 48 is positioned a selected distance apart from each other.

Each of the fasteners 50 is selectively tightened to retain the cage 12 in the deployed position such that the cage 12 forms a rectangular cube. The bottom end 24 corresponding to the first uprights 38 is aligned with the bottom end 34 corresponding to the second uprights 40 when the cage 12 is in the deployed position. Thus, the cage 12 may be positioned to surround the plant 18. Each of the fasteners 50 may comprise a bolt and a wing nut or the like.

Each of the fasteners 50 is selectively loosened such that the cage 12 is positionable in the collapsed position. The first pair of uprights 38 is positioned adjacent to the second pair of uprights 40 when the cage 12 is positioned in the collapsed position. The bottom end 34 corresponding to the first uprights 38 is spaced upwardly from the bottom end 34 corresponding to the second uprights 40. Each of the third set of supports 46 and the fourth set of supports 48 extend upwardly between the associated first uprights 38 and the associated second uprights 40 when the cage 12 is positioned in the collapsed position.

In use, each of the first set of supports 42, the second set of supports 44, the third set of supports 46 and the fourth set of supports 48 are positioned at a selected point along each of the uprights 20. The fasteners 50 are extended through the selected first set of apertures 34 and the selected second set of apertures 36 such that each of the first set of supports 42, the second set of supports 44, the third set of supports 46 and the fourth set of supports 48 are retained at the selected point along each of the uprights 20. The cage 12 is positioned in the deployed position and each of the fasteners 50 is tightened. The cage 12 is positioned to surround the plant 18. Each of the first set of supports 42, the second set of supports 44, the third set of supports 46 and the fourth set of supports 48 are repositioned as the plant 18 grows. Thus, the cage 12 continually provides support for the plant 18 as the plant 18 grows. The cage 12 s positioned in the collapsed position and the cage 12 s stored when the growing season has ended.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A plant cage assembly comprising:
a cage having a plurality of members, each of said members being movably coupled together such that said cage is positionable between a deployed position and a collapsed position, said cage being configured to surround a plant when said cage is positioned in said deployed position thereby facilitating said cage to support the plant, said cage being configured to be stored when said cage is positioned in said collapsed position.

2. The assembly according to claim 1, wherein said plurality of members comprises a plurality of uprights, each of said uprights having a top end, a bottom end and a peripheral surface extending between said top end and said bottom end, said peripheral surface having a first side and a second side, said first side and said second side forming a right angle with each other, each of said uprights being elongated between said top end and said bottom end, said bottom end of each of said uprights being tapered to a point wherein said bottom end of each of said uprights is configured to penetrate a support surface, said plurality of uprights comprising a pair of first uprights and a pair of second uprights.

3. The assembly according to claim 2, further comprising a first set of supports, each of said first set of supports being movably coupled between said first side corresponding to said pair of first uprights such that said pair of first uprights is spaced apart from each other, said first set of supports being spaced apart from each other and distributed along said pair of first uprights.

4. The assembly according to claim 2, further comprising a second set of supports, each of said second set of supports being movably coupled between said first side corresponding to said pair of second uprights such that said pair of second uprights is spaced apart from each other, said second set of supports being spaced apart from each other and distributed along said second uprights.

5. The assembly according to claim 2, further comprising a third set of supports, each of said third set of supports being movably coupled between said second side corresponding to an associated one of said pair of first uprights and said second side corresponding to an associated one of said second uprights, said third set of supports being spaced apart from each other and distributed along said associated first upright and said associated second upright.

6. The assembly according to claim 2, further comprising a fourth set of supports, each of said fourth set of supports being movably coupled between said second side corresponding to an associated one of said pair of first uprights and said second side corresponding to an associated one of said second uprights, said fourth set of supports being spaced apart from each other and distributed along said associated first upright and said associated second upright.

7. The assembly according to claim 1, further comprising:
a pair of first uprights;
a pair of second uprights;
a first set of supports being movably coupled between said first uprights;
a second set of supports being movably coupled between said second uprights;
a third set of supports being movably coupled between an associated one of said first uprights and an associated one of said second uprights;
a fourth set of supports being movably coupled between an associated one of said first uprights and an associated one of said second uprights; and
a plurality of fasteners, each of said fasteners extending through an associated one of said first set of supports and said pair of first uprights, said second set of supports and said pair of second uprights, said third set of supports and said associated first upright and said associated second upright and said fourth set of supports and said associated first upright and said associated second upright.

8. The assembly according to claim 7, wherein:
each of said first uprights and said second uprights having a bottom end; and
each of said fasteners being selectively tightened to retain said cage in said deployed position such that said cage forms a rectangular cube having said bottom end corresponding to said first uprights being aligned with said bottom end corresponding to said second uprights wherein said cage is configured to surround the plant.

9. The assembly according to claim 8, wherein each of said fasteners is selectively loosened such that said cage is positionable in said collapsed position having said first pair of uprights being positioned adjacent to said second uprights having said bottom end corresponding to said first uprights being spaced upwardly from said bottom end corresponding to said second uprights, said each of said third set of supports and said fourth set of supports extending upwardly between said associated first uprights and said associated second uprights when said cage is positioned in said collapsed position.

10. A plant cage assembly comprising:
a cage having a plurality of members, each of said members being movably coupled together such that said cage is positionable between a deployed position and a collapsed position, said cage being configured to surround a plant when said cage is positioned in said deployed position thereby facilitating said cage to support the plant, said cage being configured to be stored when said cage is positioned in said collapsed position, said plurality of members comprising:
a plurality of uprights, each of said uprights having a top end, a bottom end and a peripheral surface extending between said top end and said bottom end, said peripheral surface having a first side and a second side, said first side and said second side forming a right angle with each other, each of said uprights being elongated between said top end and said bottom end, said bottom end of each of said uprights being tapered to a point wherein said bottom end of each of said uprights is configured to penetrate a support surface, said plurality of uprights comprising a pair of first uprights and a pair of second uprights,
a first set of supports, each of said first set of supports being movably coupled between said first side corresponding to said pair of first uprights such that said pair of first uprights is spaced apart from each other, said first set of supports being spaced apart from each other and distributed along said pair of first uprights,
a second set of supports, each of said second set of supports being movably coupled between said first side corresponding to said pair of second uprights such that said pair of second uprights is spaced apart from each other, said second set of supports being spaced apart from each other and distributed along said second uprights,
a third set of supports, each of said third set of supports being movably coupled between said second side corresponding to an associated one of said pair of first uprights and said second side corresponding to an associated one of said second uprights, said third set of supports being spaced apart from each other and distributed along said associated first upright and said associated second upright,
a fourth set of supports, each of said fourth set of supports being movably coupled between said second side corresponding to an associated one of said pair of first uprights and said second side corresponding to an associated one of said second uprights, said fourth set of supports being spaced apart from each other and distributed along said associated first upright and said associated second upright, and
a plurality of fasteners, each of said fasteners extending through an associated one of said first set of supports and said pair of first uprights, said second set of supports and said pair of second uprights, said third set of supports and said associated first upright and said associated second upright and said fourth set of supports and said associated first upright and said associated second upright, each of said fasteners being selectively tightened to retain said cage in said deployed position such that said cage forms a rectangular cube having said bottom end corresponding to said first uprights being aligned with said bottom end corresponding to said second uprights wherein said cage is configured to surround the plant, each of said fasteners being selectively loosened such that said cage is positionable in said collapsed position having said first pair of uprights being positioned adjacent to said second uprights having said bottom end corresponding to said first uprights being spaced upwardly from said bottom end corresponding to said second uprights, said each of said third set of supports and said fourth set of supports extending upwardly between said associated first uprights and said associated second uprights when said cage is positioned in said collapsed position.
